(19) United States
(12) Patent Application Publication
(10) Pub. No.: US 2018/0365720 A1
(43) Pub. Date: Dec. 20, 2018

(54) CONTROLS MODULE

(71) Applicant: Hiperos, LLC, Westborough, MA (US)

(72) Inventors: Dov Joseph Goldman, Flushing, NY (US); Sandeep Damodar Bhide, Randolph, NJ (US); Michael David Angle, Warwick, NY (US)

(21) Appl. No.: 16/010,591

(22) Filed: Jun. 18, 2018

Related U.S. Application Data
(60) Provisional application No. 62/521,483, filed on Jun. 18, 2017.

(51) Int. Cl. G06Q 30/02; G06F 17/30; G06Q 10/06

(52) U.S. Cl. CPC G06Q 30/0203; G06Q 10/0635; G06F 17/30964

(57) ABSTRACT

Methods for minimizing bandwidth associated with transmission of unnecessary queries to third party vendors is provided. Methods may include transmitting initial queries to the third party vendors. Methods may include receiving a result set corresponding to the initial queries. Methods may further include mapping the initial queries, with the result set to a set of controls. Methods may include creating a personalized set of subsequent queries based on the mapping to the set of controls. Methods may include transmitting the subsequent queries to the third party vendor. Methods may include receiving a result set corresponding to the second set of queries.

### CROSS-REFERENCE TO RELATED APPLICATION

This application claims priority from prior U.S. Provisional Patent Application No. 62/521,483, entitled “CONTROLS MODULE”, filed on Jun. 18, 2017, which is hereby incorporated by reference herein in its entirety.

### FIELD OF THE INVENTION

This disclosure relates to third party management. Specifically, this disclosure relates to apparatus, methods and architecture for simplifying third party management.

### BACKGROUND OF THE INVENTION

Third party management may involve managing multiple, and varied, third party vendors. Many different vendors may be included with the scope of such management.

It may be desirable to increase efficiencies associated with monitoring of third parties and with managing interactions with third parties. Such increase in efficiencies may include reducing effort used for the monitoring of third parties and with managing interactions with third parties.

### SUMMARY OF THE DISCLOSURE

A controls module is provided. The controls module may include a transmitter. The transmitter may be configured to a first set of queries to an entity. The first set of queries may also be referred to herein as initial queries.

The controls module may include a receiver. The receiver may be configured to receive a result set from the first entity. The result set may correspond to the first set of queries.

The controls module may include a processor. The processor may be configured to process the result set corresponding to the first set of queries. The processing may include using a query/control relationship map to determine a second set of queries. The second set of queries may also be referred to herein as subsequent queries. The second set of queries may be a subset of a plurality of queries. The second set of queries may be applicable to the first entity. The query/control relationship map may map the first set of queries to the second of queries via a plurality of controls.

Each control may be a data structure. Each control may include a plurality of associations. Each control may include associations with the first set of queries. Each control may include associations with the second set of queries. There may be a one-to-one relationship between a control and a query—i.e., one specific initial query may relate to one specific control, or one specific control may relate to one specific subsequent query. There may be a one-to-one relationship between a control and a query—i.e., one specific initial query may relate to many controls, or one specific control may relate to many subsequent queries. There may be a many-to-many relationship between a control and a query—i.e., many controls may relate to many subsequent queries, or many initial queries may relate to many controls. It should be appreciated that many other variations of relationships between initial queries, subsequent queries and controls are considered within the scope of the invention.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative flow diagram in accordance with principles of the invention;

FIG. 2 shows another illustrative flow diagram in accordance with principles of the invention;

FIG. 3 shows an illustrative mapping model in accordance with principles of the invention;

FIG. 4 shows an illustrative flow chart in accordance with principles of the invention;

FIG. 5 shows an annotated illustrative flow chart in accordance with principles of the invention;

FIG. 6 shows an illustrative graphical user interface (“GUI”) in accordance with principles of the invention;

FIG. 7 shows another illustrative GUI in accordance with principles of the invention;

FIG. 8 shows yet another illustrative GUI in accordance with principles of the invention;

FIG. 9 shows still another illustrative GUI in accordance with principles of the invention;

FIG. 10 yet another illustrative GUI in accordance with principles of the invention;

FIG. 11 shows still another illustrative GUI in accordance with principles of the invention;

FIG. 12 shows yet another illustrative GUI in accordance with principles of the invention;

FIG. 13 shows still another illustrative GUI in accordance with principles of the invention;

FIG. 14 shows yet another illustrative GUI in accordance with principles of the invention;

FIG. 15 shows still another illustrative GUI in accordance with principles of the invention;

FIG. 16 shows yet another illustrative GUI in accordance with principles of the invention;

FIG. 17 shows still another illustrative GUI in accordance with principles of the invention;

FIG. 18 shows yet another illustrative GUI in accordance with principles of the invention;

FIG. 19 shows still another illustrative GUI in accordance with principles of the invention;

FIG. 20 shows yet another illustrative GUI in accordance with principles of the invention;

FIG. 21 shows still another illustrative GUI in accordance with principles of the invention;

FIG. 22 shows yet another illustrative GUI in accordance with principles of the invention;

FIG. 23 shows still another illustrative GUI in accordance with principles of the invention;

FIG. 24 shows yet another illustrative GUI in accordance with principles of the invention; and

FIG. 25 shows still another illustrative GUI in accordance with principles of the invention.

### DETAILED DESCRIPTION OF THE DISCLOSURE

A system for control-questionnaire relationship mapping is provided. The system may include an entity information receiving module. The entity information receiving module may receive entity information. The entity information may be received from the entity identified by the entity information. The entity information may be received from an entity associated with the entity identified by the entity information. The entity information may be static for a predetermined entity. The entity information may be static for a predetermined time period for a predetermined entity.

The system may include a standard information gathering (“SIG”) module. The SIG module may transmit a SIG questionnaire to either one of an entity, a vendor or a third party. The SIG questionnaire may relate to the vendor, the entity and/or a relationship between the vendor and the entity.

The SIG module may receive the SIG questionnaire populated with a SIG response result set. The SIG module may receive the SIG response result set from the entity, the vendor and/or the third party.

The SIG module may process the SIG questionnaire populated with the SIG response result set. Processing the SIG questionnaire may include determining a set of controls. The determined set of controls may be applicable to both the entity and the vendor. Each control, included in the determined set of controls, may be associated with a plurality of evidence questions. In some embodiments, a subset of the determined set of controls may be one or more entity-defined controls. In other embodiments, a subset of the determined set of controls may be one or more stock controls.

An exemplary control may be an acceptable use policy information security and infrastructure risk governance control. An evidence question associated with this exemplary control may include a request for documents associated with a risk assessment program. The request for documents may include requests for a services organization controls 2 (SOC2), a risk governance plan, a business continuity policy/disaster recovery policy, risk policies and procedures, a range of business assets to be evaluated, a risk training plan, risk scenarios, risk evaluation criteria and periodic review of program documentation.

At times, some of the evidence questions associated with one control may be identical or substantially identical to some evidence questions associated with another control. In these instances, a subset of the plurality of evidence questions associated with a first control, included in the determined set of controls, may be identical, or substantially identical, to a subset of the plurality of evidence questions associated with a second control, included in the determined set of controls.

The system may include an evidence questionnaire module. The evidence questionnaire module may generate an evidence questionnaire. The generated evidence questionnaire may be specific to the vendor. The generated evidence questionnaire may include a unique set of evidence questions—i.e., each evidence question may be included once in the questionnaire. The unique set of evidence questions may include evidence questions associated with each control included in the determined set of controls. The evidence questionnaire may be agnostic to which questions, included in the evidence questionnaire are associated with which controls.

The evidence questionnaire may also maintain an evidence questionnaire relationship map. The evidence questionnaire relationship map may relate, link or associate an evidence question to one or more controls. The evidence questionnaire may include relationships, links or associations between each evidence question, included in the unique set of evidence questions, and the determined set of controls.

The evidence questionnaire module may transmit the evidence questionnaire to the vendor. The evidence questionnaire module may also receive the evidence questionnaire, populated with an evidence response set. The evidence response set may include one or more data elements, one or more pieces of evidence and/or one or more documents. A data element, piece of evidence or document may be mapped and/or linked to one control or a plurality of controls.

The system may include an updater module. The updater module may update the evidence questionnaire relationship map to include the received evidence response set.

The system may include a database. The database may store the received evidence questionnaire. The database may also store the updated evidence questionnaire relationship map.

In some embodiments, once the evidence response set is received, the updater module may delete the evidence questions from the evidence questionnaire relationship map. The updater module may maintain, even after the deleting the evidence questions, the relationship between each response included in the evidence response set and the set of controls.

In some embodiments, an entity may be associated with a plurality of vendors. In these embodiments, the SIG module may be configured to transmit a plurality of SIG questionnaires. Each of the SIG questionnaires may be linked to, or associated with, one of the plurality of vendors. Each SIG questionnaire may be transmitted to the appropriate vendor. In some embodiments, the plurality of SIG questionnaire may be transmitted to the entity. In other embodiments, the SIG questionnaires may be transmitted to one or more third parties. In yet other embodiments, the plurality of questionnaires may be transmitted to a combination the entity, the vendors and the third parties.

In these embodiments, the SIG module may be configured to receive the SIG questionnaires populated with a SIG response result set. The SIG module may process the populated SIG questionnaire for each vendor. The processing may utilize the control-questionnaire relationship map. The processing may include determining a set of controls applicable to both the vendor and the entity.

In these embodiments, the evidence questionnaire module may generate an entity-specific and vendor-specific questionnaire for each vendor. The entity-specific and vendor-specific questionnaire may specify the vendor to which the evidence questionnaire is transmitted. The evidence questionnaire module may also maintain an evidence questionnaire relationship map for each entity-specific and vendor-specific questionnaire. The evidence questionnaire module may transmit each entity-specific and vendor-specific evidence questionnaire to the vendor specified in the evidence questionnaire.

In these embodiments, the evidence questionnaire module may receive one or more entity-specific and vendor-specific evidence questionnaires populated with an evidence response set.

In these embodiments, the updater module may update the evidence questionnaire relationship map to include the received evidence response set. The database may store the updated evidence questionnaire relationship map.

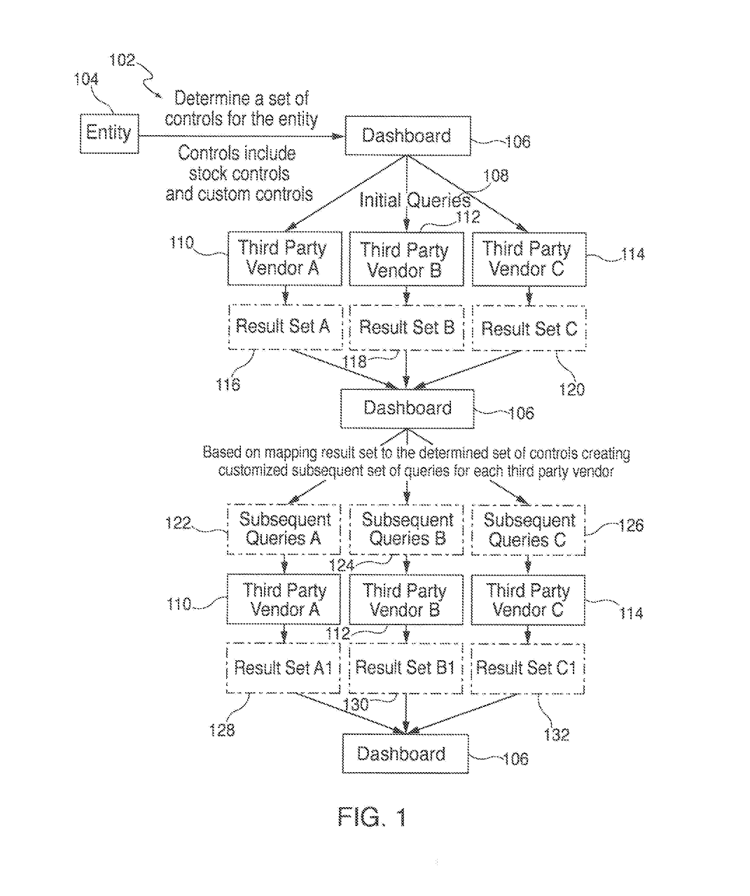

FIG. 1 shows illustrative flow chart 102. Entity information relating to entity 104 may be received. The entity information may be received in response to receipt of a results set included in a populated entity questionnaire.

Entity information may be received via ad hoc methods, such as an e-mail, telephone conversation, in-person conversation or the like. The entity information may include entity bibliographic data, such as name, legal name, address, phone number, e-mail address information, website information, employee information and any other suitable information. The entity information may also include entity-specific information, such as the type of entity—e.g., hospital, financial institution, school, or non-profit organization—, entity client base, entity supplier base and any other suitable entity-specific information. The entity information may be stored in, and/or displayed on, dashboard 106.

A set of controls applicable to entity 104 may be determined based on the entity information. The set of controls may include stock controls such as controls included in well-known frameworks, such as an acceptable use policy framework, a National Institute of Standards and Technology (“NIST”) cybersecurity framework, a NIST special publication security controls and assessment procedures for federal information systems and organizations framework, an international organization for standardization (“ISO”) framework, a PCI (a standard for connecting computers and their peripherals) framework, a HIPAA (Health Insurance Portability and Accountability act of 1996, a United States legislation, that provides data privacy and security provisions for safeguarding medical information) compliance framework, a COSO (The Committee of Sponsoring Organization of the Treadway Commission) compliance framework, a COBIT (Control Objectives for Information and related Technologies) framework, as well as any other suitable framework. Examples of such controls include NIST Identity Management and Access Control and NIST Critical Security Control.

The set of controls may include custom controls, such as entity-defined controls.

In some embodiments, a set of controls may be determined based on entity information and then refined based on the result set received in response to initial queries (shown at 116, 118 and 120). In other embodiments, the set of controls may be determined after both the entity information is received from the entity and the result set received in response to the initial queries (shown at 116, 118 and 120).

A set of initial queries 108 may be transmitted to a plurality of third party vendors associated with entity 104. In some embodiments, initial queries 108 may be specific to entity 104. In other embodiments, initial queries 108 may be standard information-gathering (“SIG”) questionnaires. SIG questionnaires may be standardized questionnaires received from a questionnaire library. At times, SIG questionnaires may also be customized for a specific entity.

Third party vendors 110-114 may respond to initial queries 108. The responses provided by each third party vendor may be indicated as result sets A, B and C, shown at 116, 118 and 120. Result sets A, B and C may be stored in, and/or displayed on, dashboard 106.

In some embodiments, initial queries 108 may be presented to third party vendors 110-114 within dashboard 106, and third party vendors 110-114 may respond to initial queries 108 within dashboard 106. In this embodiment, dashboard 106 may be used as a central location to communicate with entities and third party vendors.

It should be appreciated that, in some embodiments, initial queries 108 may be transmitted to a relationship manager associated with entity 104. In this embodiment, the relationship manager may answer the SIG questionnaire for each of third party vendors 110-114.

In yet other embodiments, one SIG questionnaire may be answered for all third parties associated with entity 104. In these embodiments, information received relating to entity 104 may be included in the SIG questionnaire (or initial queries 108).

Upon receipt of result sets A, B and C at dashboard 106, a set of controls may either be determined or refined for each third party vendor. In some embodiments, the set of controls may be not be determined or refined.

Rather, the questions, otherwise referred to herein as subsequent queries, associated with each of the controls may be selected from a plurality of controls. The selection may be made based on the received result sets A, B and/or C.

A set of subsequent queries, shown at 122-126, may be determined for each third party vendor, shown at 110-114. In some embodiments, each set of subsequent queries 122-126 may be transmitted to each third party vendor. In other embodiments, each set of subsequent queries 122-126 may be posted to dashboard 106 for viewing/completing by each third party vendor. Each third party vendor may provide answers to the set of subsequent queries. The answers provided to the set of subsequent queries may be known as a result set. Result sets A1, B1 and C1, shown at 128, 130 and 132 may include the answers provided by third party vendors A, B and C to subsequent queries A, B and C, respectively.

At times, result sets A1, B1 and C1 may be provided at dashboard 106. In other embodiments, result sets A1, B1 and C1 may be posted to dashboard 106 once they are received.

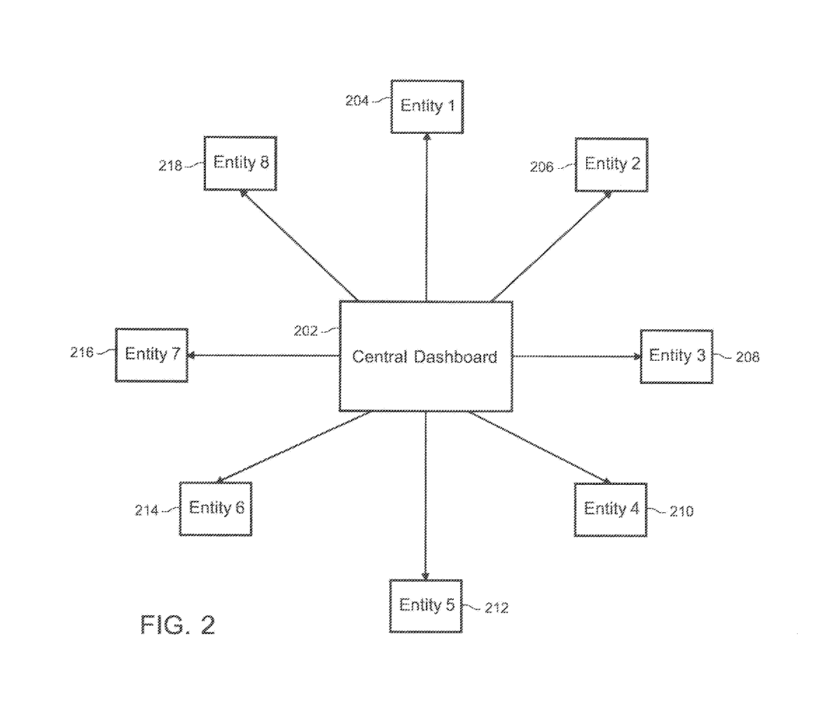

FIG. 2 shows an illustrative flow diagram. The flow diagram shown in FIG. 1 may be multiplied numerous times for an entities' many vendors.

Central dashboard 202 may include a centralized software module for communicating with entities, vendors and/or third parties. Central dashboard 202 may enable communication between entities and vendors, entities and third parties and/or vendors and third parties. Central dashboard 202 may, on behalf of each entity, communicate and manage the entity's vendors and the relationships between each entity and its vendors. Central dashboard 202 may be coupled to a database. The database may store the information received at, and transmitted from, central dashboard 202. Central dashboard 202 may be shown as associated with entity 1-8, as shown at 204-218.

Central dashboard may also be associated with one or more vendors (not shown) and one or more third parties (not shown). It should be appreciated that, in certain embodiments, one vendor may be associated with more than one entity. In these embodiments, one entity may enable a second entity to view a result set of a shared vendor. Information, such as common vendors and their result sets may be shared between entities at central dashboard 202 in a network-like environment.

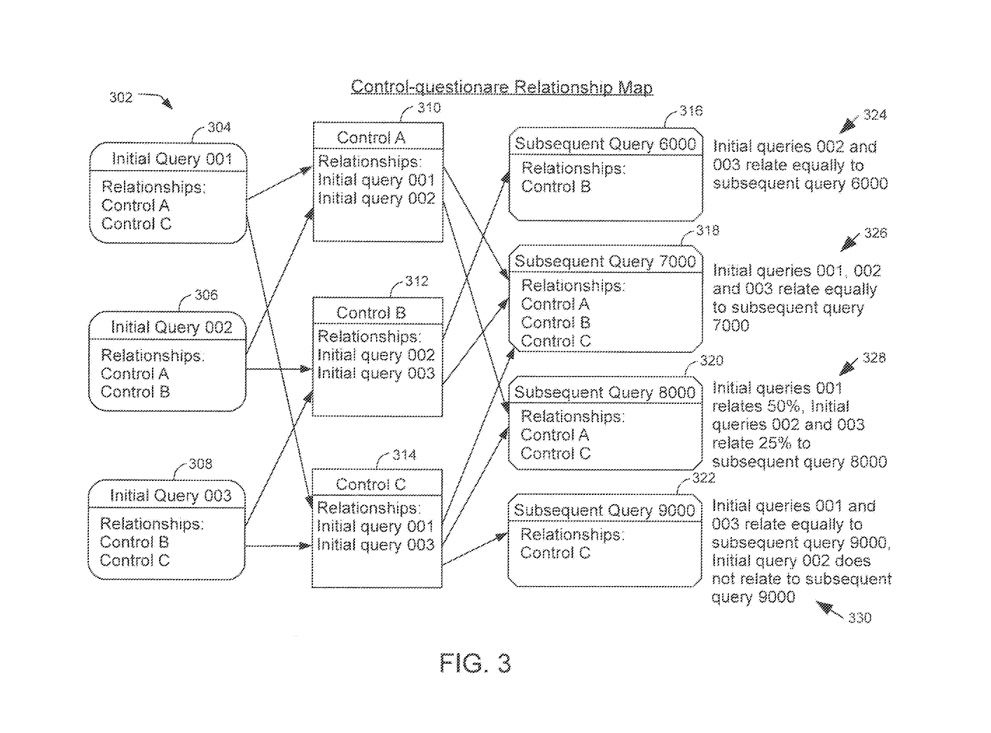

FIG. 3 shows an illustrative superstructure of information architecture of a control questionnaire relationship map used for processing. The illustrative superstructure, also referred to herein as a mapping model, may be used to model a control questionnaire relationship map. Relationship map 302 may include a plurality of initial queries. The plurality of initial queries may include entity questions and/or SIG questions.

Initial query 001, shown at 304, initial query 002, shown at 306 and initial query 003, shown at 308 may be included in the plurality of initial queries. Each initial query may include relationships with zero, one or more of a plurality of controls. Controls A, B and C, shown at 310, 312 and 314 may include relationships with initial queries shown at 304, 306 and/or 308. A control may be a stock control retrieved from a well-known framework, such as those discussed in connection with FIG. 1. In some embodiments, a control may be a data structure for defining relationships between initial queries and subsequent queries.

Use of controls may conserve resources. As opposed to determining individual subsequent queries for each third party vendor, the control system may determine a set of controls for each third party vendor. Each control may be associated with a predetermined selection of subsequent queries. Therefore, the control system selects a small number of controls as compared to a large number of subsequent queries. Subsequent queries, shown at 316-322, may also be referred to herein as evidence questions. The controls, when used together with a control algorithm, shown in an exemplary manner at 324-330, may only transmit relevant subsequent queries to entities. The transmission of smaller amounts of relevant data (found in smaller, more targeted, subsequent queries) as opposed to large amounts of irrelevant data, may enable the central dashboard, or control system, to transmit queries to a larger number of vendors in a shorter time frame than was being transmitted in conventional architecture. Additionally, the magnitude turnaround time for receipt of the result set to the subsequent queries from each of the vendors may be reduced because vendors are required to answer fewer queries. Furthermore, the amount of bandwidth usage between a central dashboard or control system transmitter and a first entity may be considerably reduced. The bandwidth use reduction may enable larger, more efficient, data traffic flows.

A central dashboard or control system transmitter may be configured to transmit the subsequent queries to the appropriate vendors. In some embodiments, the transmitter may notify the appropriate vendors that subsequent queries are available to be answered. Upon receipt of the subsequent queries and/or the notification, the vendor may be prompted to provide answers and/or results to the subsequent queries. Upon vendor completion of the subsequent set of queries, the vendor may transmit the result set to the central dashboard or control system. In other embodiments, upon vendor completion of the subsequent set of queries, the vendor may select a “transmit” trigger to transmit the query to the appropriate location or recipient. The receiver, at the central dashboard or controls system may be configured to receive and process the result set corresponding to the subsequent queries.

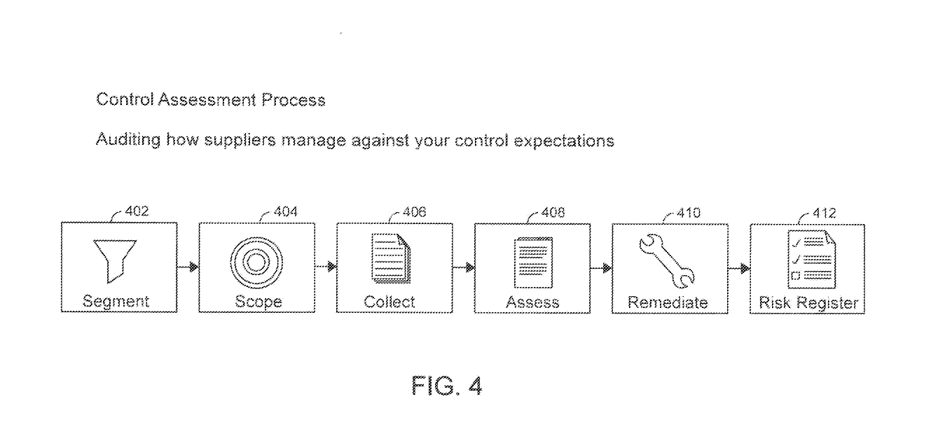

FIG. 4 shows a controls assessment process. A controls assessment process may provide for auditing how, or whether, an entity's suppliers, vendors or other third parties comply with the entity's control expectations. Control expectations may include risk management, information security qualifications and other information relating to behaviors or attributes of the third parties. The control assessment process may include a first step—segment, shown at 402. The control assessment process may include a second step—scope, shown at 404. The control assessment process may include a third step—collect, shown at 406. The control assessment process may include a fourth step—assess, shown at 408. The control assessment process may include a fifth step—remediate, shown at 410. The control assessment process may include a sixth step—risk register, shown at 412.

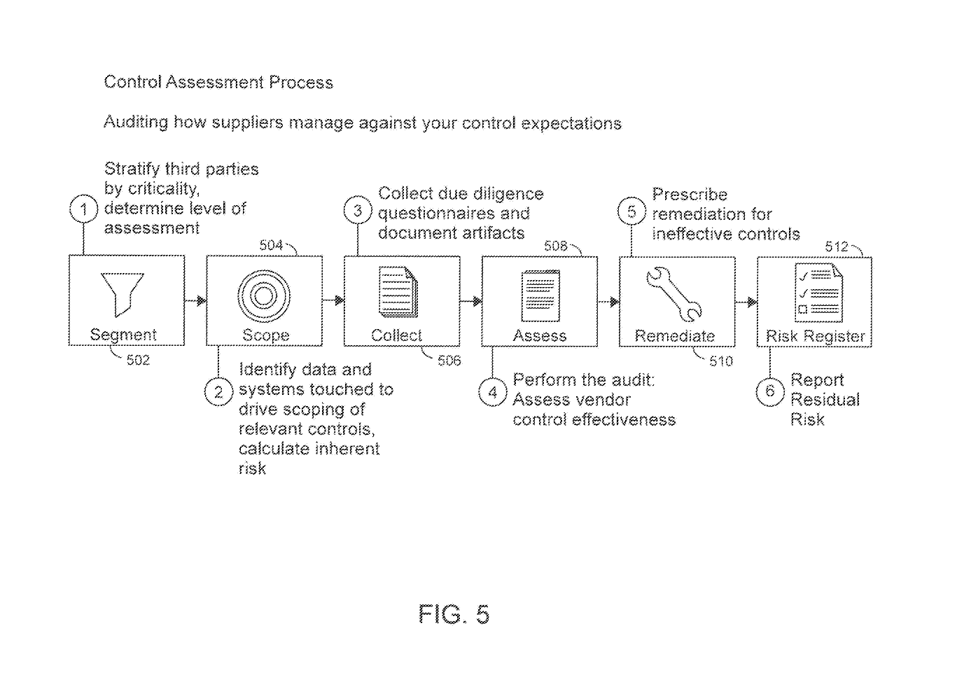

FIG. 5 shows an annotated version of the controls assessment process shown in FIG. 4. The first step—segment, shown at 502, may include stratifying third parties—i.e., third party vendors—by criticality. The first step may also include determining a level of assessment.

In some embodiments, criticality may be determined by the type of information being processed by a third party vendor. A landscaping vendor may be privy to minimal information about an entity to which it is providing landscaping services, and therefore, may be placed into a low-risk segment for the entity. A data cloud vendor that stores employee personal information, trade secrets and other proprietary information for an entity may be placed into a high-risk segment for the entity.

The second step—scope, shown at 504, may include identifying data and systems touched by third party vendors. The data and system identification may drive scoping of relevant controls—i.e., which queries read on target controls. The data and system identification may calculate inherent risk associated with predetermined controls.

A focal point of the assessment may include defining relationships between entities and their respective third party vendors. Such an entity-third party vendor relationship may be segmented or scoped into different categories of relationships. For example, one entity may have a plurality of different relationships with one third party vendor. The entity may have one relationship with at least one product of a third party vendor. The entity may have one relationship with at least one service of a third party vendor. The entity may have one relationship with at least one location of the third party vendor. The entity may have any other suitable relationship with a third party vendor. The entity may have multiple relationships with a single third party vendor. Each of the multiple relationships may be based on a product, service, location, or other suitable basis. Each relationship may require its own distinct assessment.

The third step—collect, shown at 506, may include collecting due diligence questionnaires and document artifacts from the third party vendors. The due diligence questionnaires may be accessed, and answered, via an online portal. The due diligence questionnaires may be downloaded from the online portal, and then, once completed, uploaded to the online portal. The document artifacts may also be submitted to the online portal via an upload function.

The fourth step—assess, shown at 508, may include performing the audit of assessing vendor control effectiveness. The audit may be based on the result set of the due diligence questionnaire and the uploaded documents.

The fifth step—remediate, shown at 510, may include prescribing various forms of remediation for ineffective controls used to assess third party vendor systems. The remediation may be determined based on the audit.

The sixth step—risk register, shown at 512, may include reporting the residual risk associated with each third party vendor and/or third party vendor relationship. The reporting may be presented to the requesting entity. The reporting may include any requested or pending remediation. Upon the realization of any requested remediation, one or more remaining risk factors that have been mitigated by the remediation may be presented, displayed or transmitted to the requesting entity.

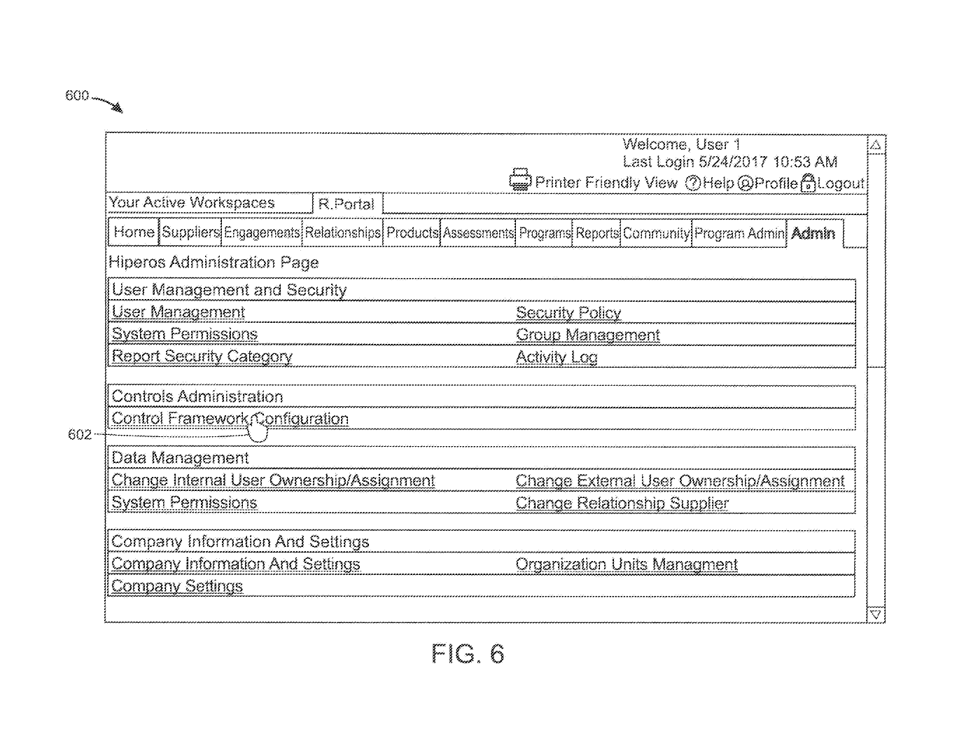

FIG. 6 shows illustrative GUI 600. GUI 600 may depict an administration webpage. The administration webpage may include options for user management and security, controls administration, data management, company information and storage. Cursor 602 may be located on hyperlink—control framework configuration—within the controls administration heading. Selection of the control framework configuration may direct a user to a webpage for control framework configuration.

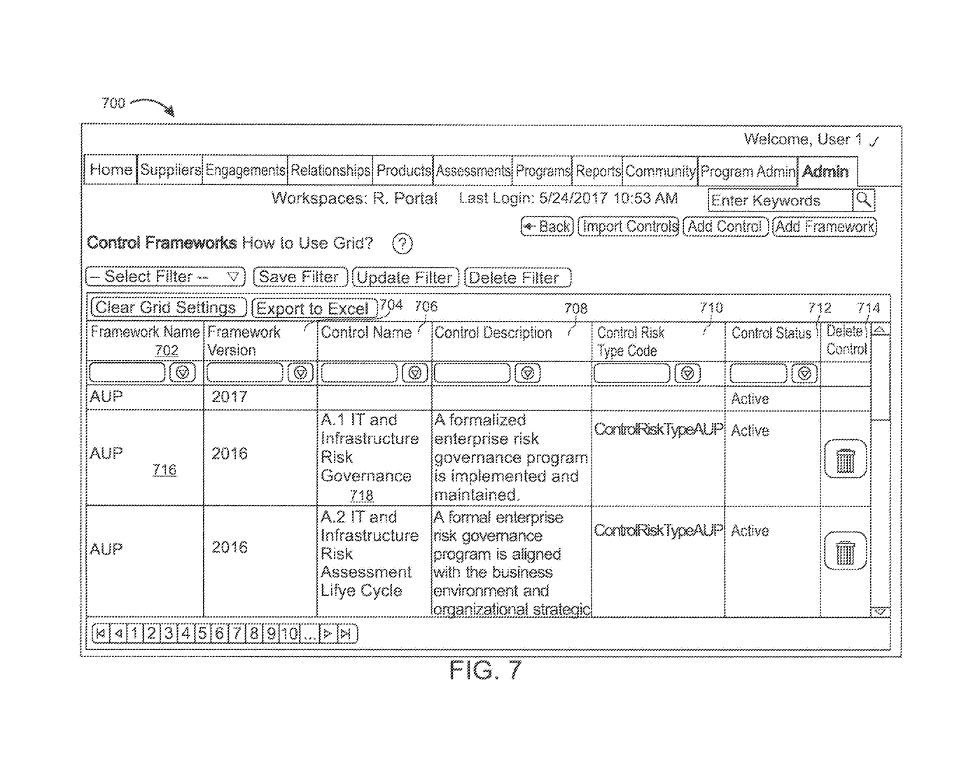

FIG. 7 shows illustrative GUI 700. GUI 700 may depict a controls framework. Upon selection of the controls framework configuration hyperlink, shown in FIG. 6, a user may be directed to GUI 700.

GUI 700 may display metadata for each control. The metadata may include a framework name, shown at 702. The metadata may include a framework version, shown at 704. The metadata may include a control name, shown at 706. The metadata may include a control description, shown at 708. The metadata may include a control risk type code, shown at 710. The metadata may include a control status, shown at 712. The metadata may include any other suitable metadata. The metadata may be configurable.

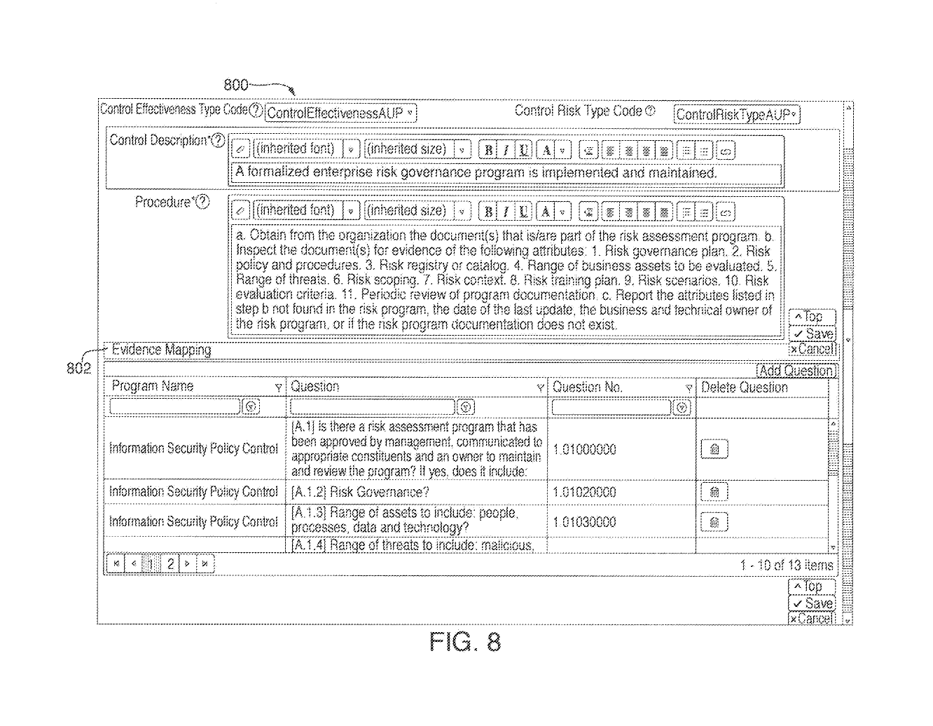

A user may specify which metadata columns he or she wishes to view. Each column may include any specified data element. The data elements may be selected from the data elements included in the more detailed view, shown in FIG. 8.

An exemplary control may be shown at 716. The name of the control may be A.1—IT and Infrastructure risk governance. Control A.1 may be described as a formalized enterprise risk governance program is implemented and maintained. The control risk type code of control A.1 may be “ControlRiskTypeAUP.” Control A.1 may be included in the AUP framework version 2016. The status of control A.1 may be active. In order to delete control A.1, a user may use the delete button included in the delete control column. The control name, shown at 718, may be a hyperlink. The hyperlink may direct a user to a more detailed view of the control.

FIG. 8 shows GUI 800. GUI 800 may include a more detailed view of the A.1 control. The control description may be editable in the more detailed view. The procedure for the control may be displayed as well as editable in the more detailed view. The procedure for control A.1 may include requesting documents from organization(s) that are part of the risk assessment program.

The procedure may include requesting, obtaining and/or inspecting any suitable document. One exemplary procedure may include inspecting the documents for evidence of a plurality of attributes. The attributes may include SOC2. SOC2 may include a report focusing on an entity's non-financial reporting controls, an acceptable use policy, business continuity policy/disaster recovery policy, a risk governance plan, risk policies and procedures, range of business assets to be evaluated, risk training plan, risk scenarios, risk evaluation criteria and periodic review of program documentation.

The procedure for control A.1 may also include reporting. The reporting may report the attributes listed but not found in the risk program. The reporting may report the date of the last update. The reporting may report the business and technical owner of the risk program. The reporting may report whether the risk program documentation does or does not exist.

Control A.1 may include and/or be associated with a plurality of queries. The queries may include question nos. 1.01000000, 1.01020000 and 1.01030000. The questions may be include in the evidence mapping section, shown at 802. A query, or evidence question, may include a document request, alternative to, or in combination with, a question in a questionnaire.

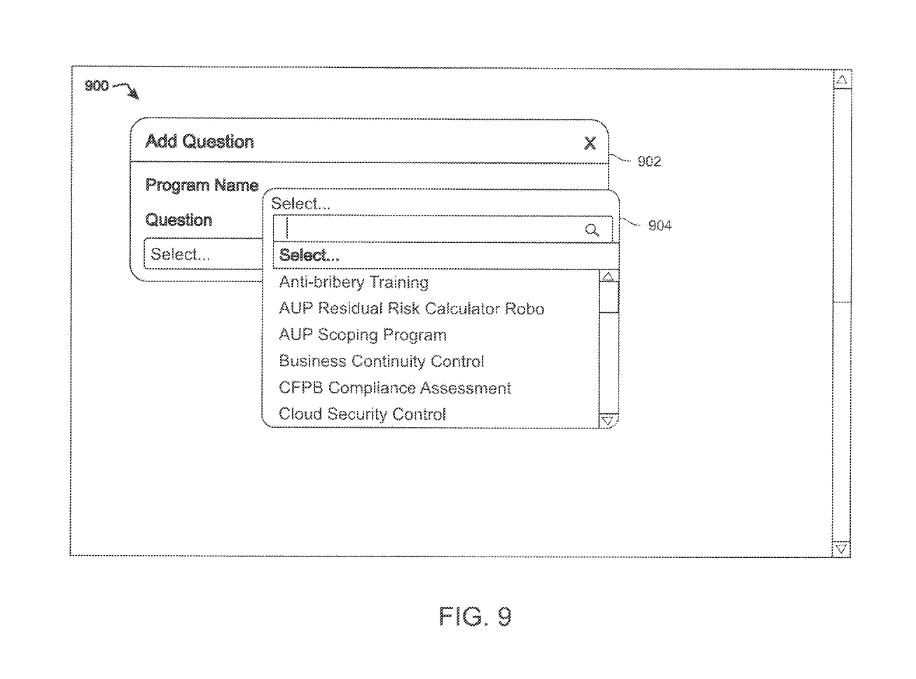

FIG. 9 shows GUI 900. A user may request the system to add a query to a specific control, as shown at 902. Initially, the user may be required to select a program name, as shown at 904. The program name may be linked to the added question.

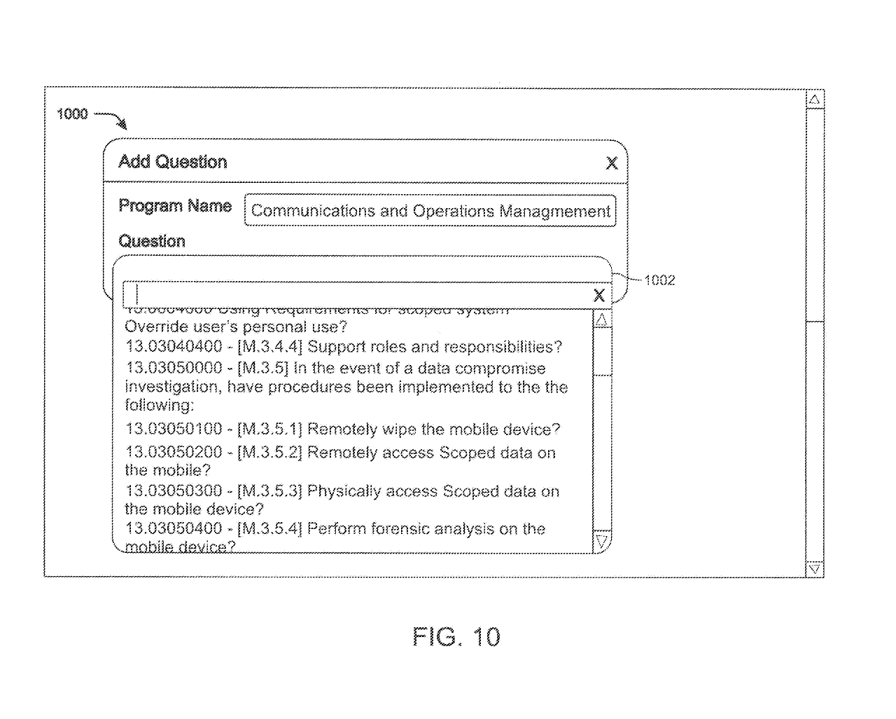

FIG. 10 shows GUI 1000. Upon selection of a program name, as shown in GUI 900, a user may be presented with a plurality of questions related to the selected program name. The user may select a question from the plurality of questions, as shown at 1002.

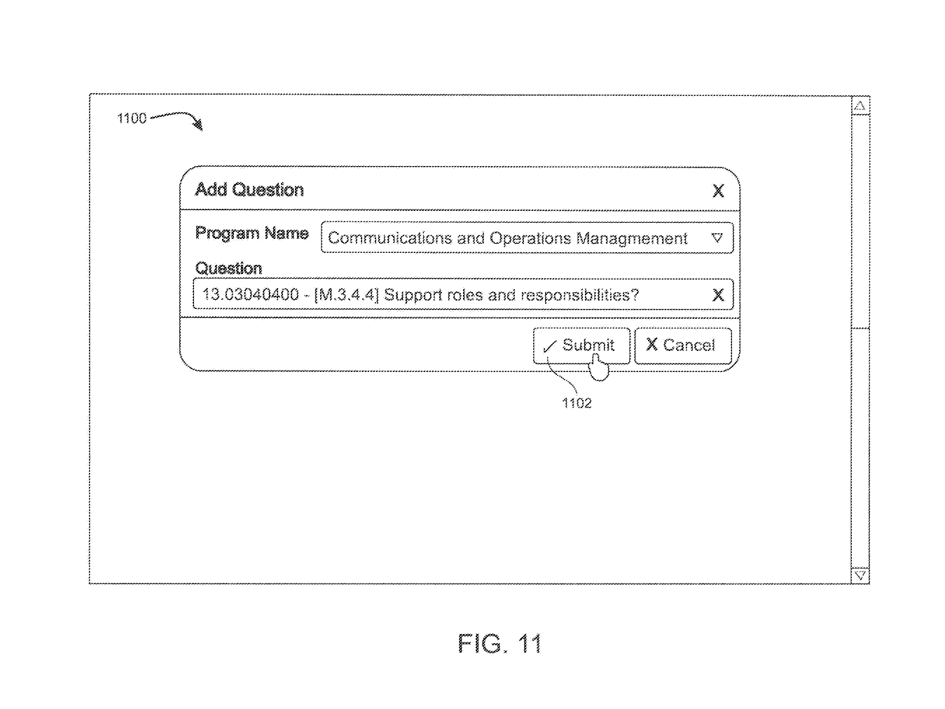

FIG. 11 shows GUI 1100. Upon selection of a question shown at GUI 1000, a user may select a submit button 1102 to add the selected question (M.3.4.4—Support roles and responsibilities) to the control.

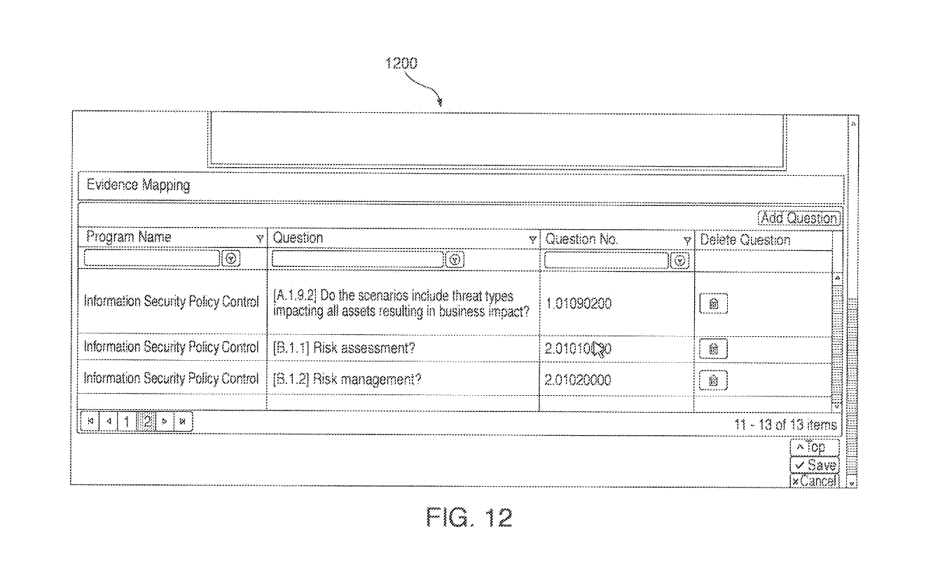

FIG. 12 shows GUI 1200. GUI 1200 may be an exemplary evidence mapping section prior to the addition of the question selected in GUI 1100.

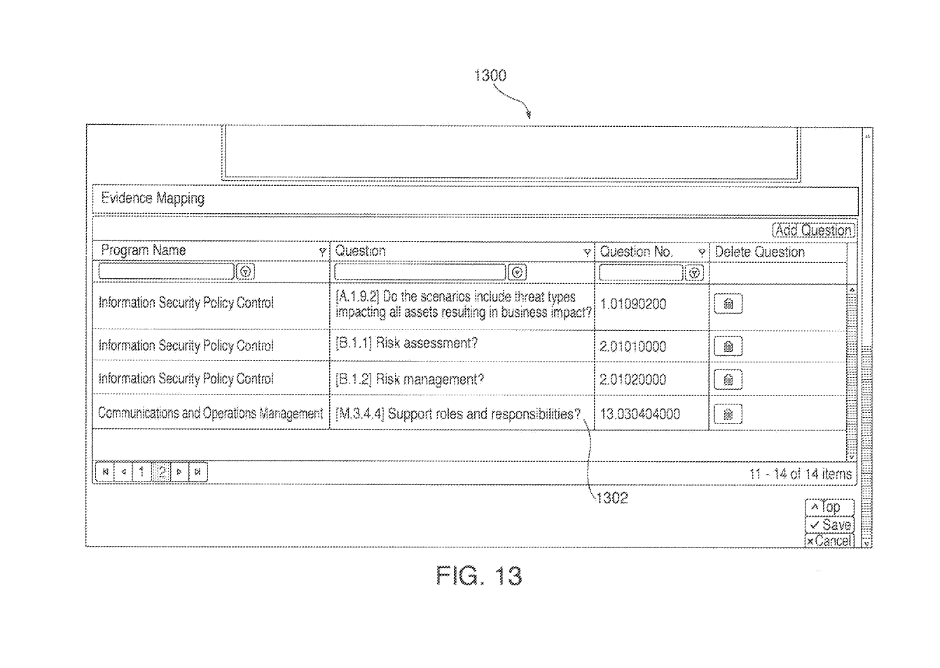

FIG. 13 shows GUI 1300. GUI 1300 may be an exemplary evidence mapping section upon completion of the addition of exemplary question—M.3.4.4—Support roles and responsibilities, shown at 1302.

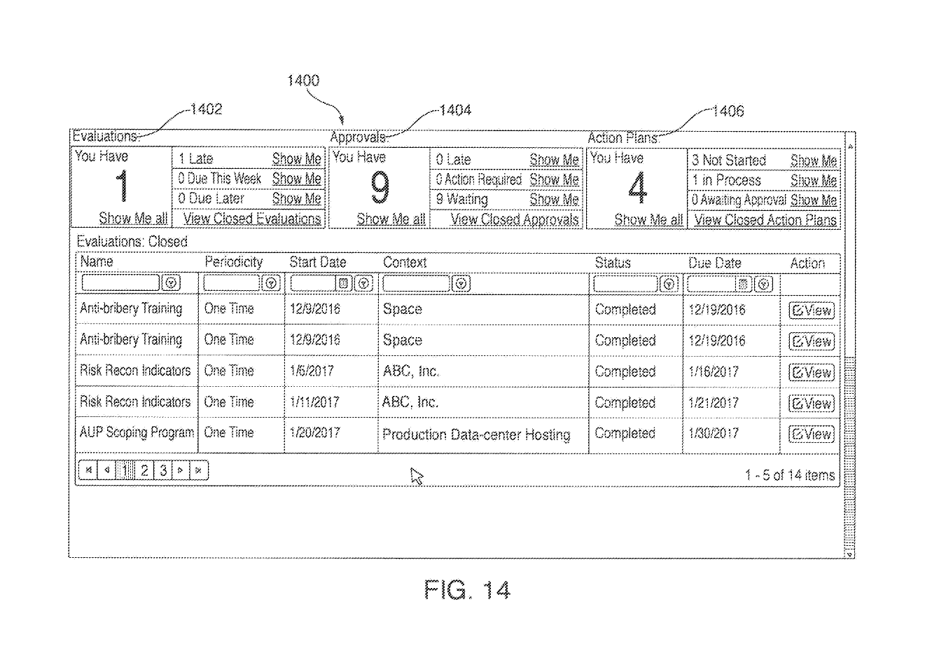

FIG. 14 shows GUI 1400. GUI 1400 may include a dashboard. The dashboard may display evaluations, shown at 1402, approvals, shown at 1404 and action plans, shown at 1406. The dashboard may be customized for a specific entity or third party vendor. Each dashboard may be separately-entitled for the viewing party.

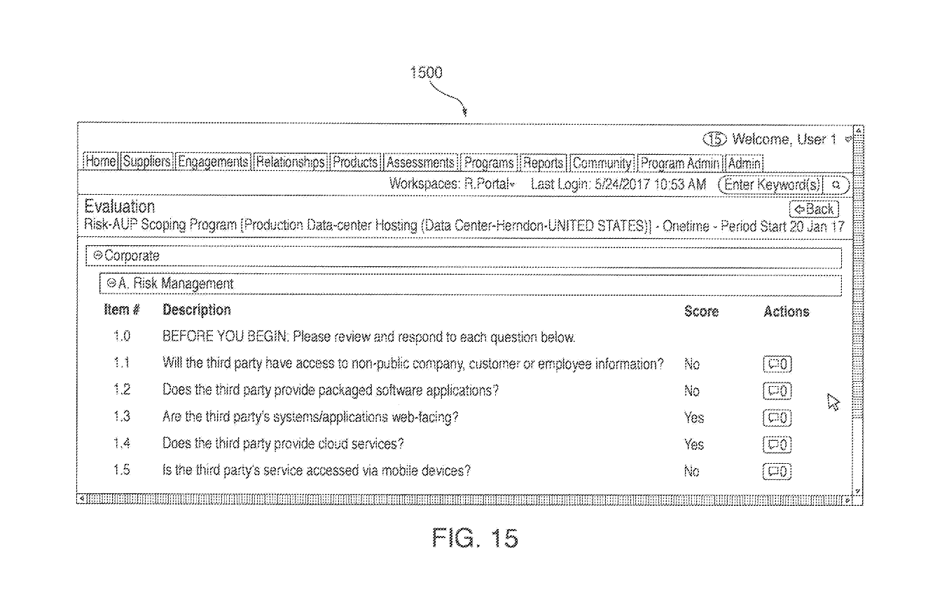

FIG. 15 shows GUI 1500. GUI 1500 may be an evaluation GUI. GUI 1500 may include a set of initial queries. GUI 1500 may include an SIG questionnaire. The initial queries may be completed, or populated, by an entity, a vendor or a third party. Evaluation GUI 1500 may be populated with answers by a first level employee. Evaluation GUI 1500 may be reviewed by a second level employee.

Upon completion and submission of evaluation GUI 1500, the system may generate a list of relevant controls for the entity and the associated third party vendor. The list of relevant controls may be configurable. The list of relevant controls may be based on industry standards.

The list of relevant controls may be based on customized information. The list of relevant controls may be based on a combination of customized information and industry standards. A set of subsequent queries that map to the relevant controls may be generated.

The entity, the vendor or a third party may complete the set of subsequent queries. In some embodiments, the entity, vendor or a third party may be enabled to complete the subsequent queries using a dashboard, such as the dashboard shown at GUI 1400.

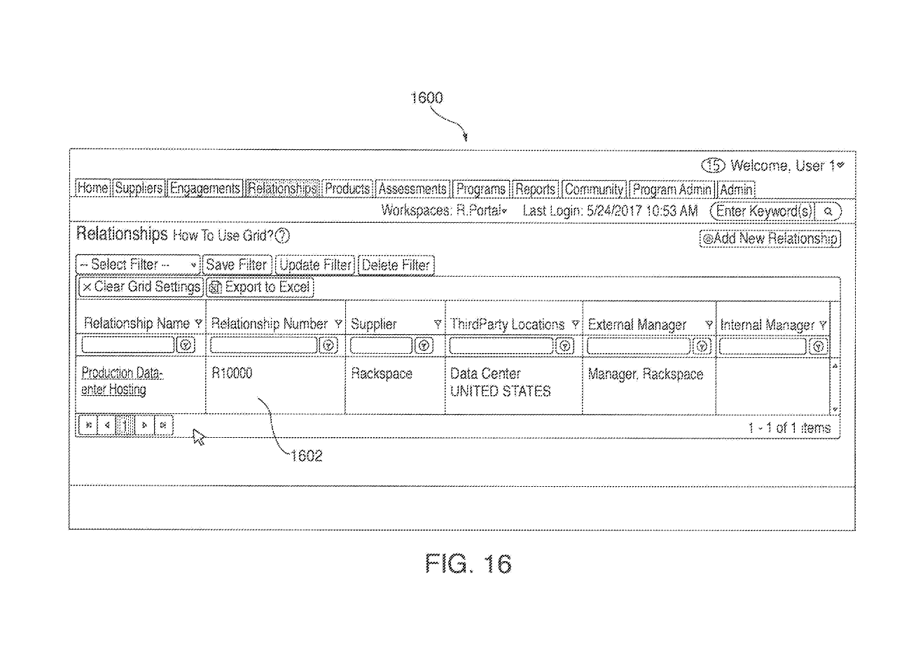

FIG. 16 shows relationship GUI 1600. A relationship may be defined as the relationship between a control and a subsequent query or between a control and an initial query. GUI 1600 may include relationship number R1000, shown at 1602.

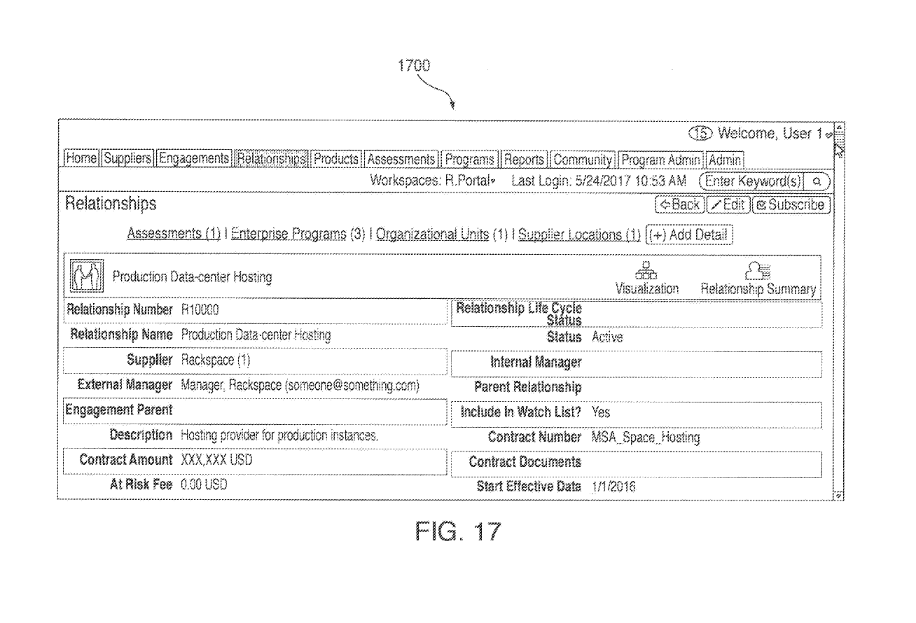

FIG. 17 shows GUI 1700. GUI 1700 may include details of relationship R1000. The details may include relationship number, relationship name, relationship parties (which control and which query), a physical visualization of the relationship and other relevant relationship details.

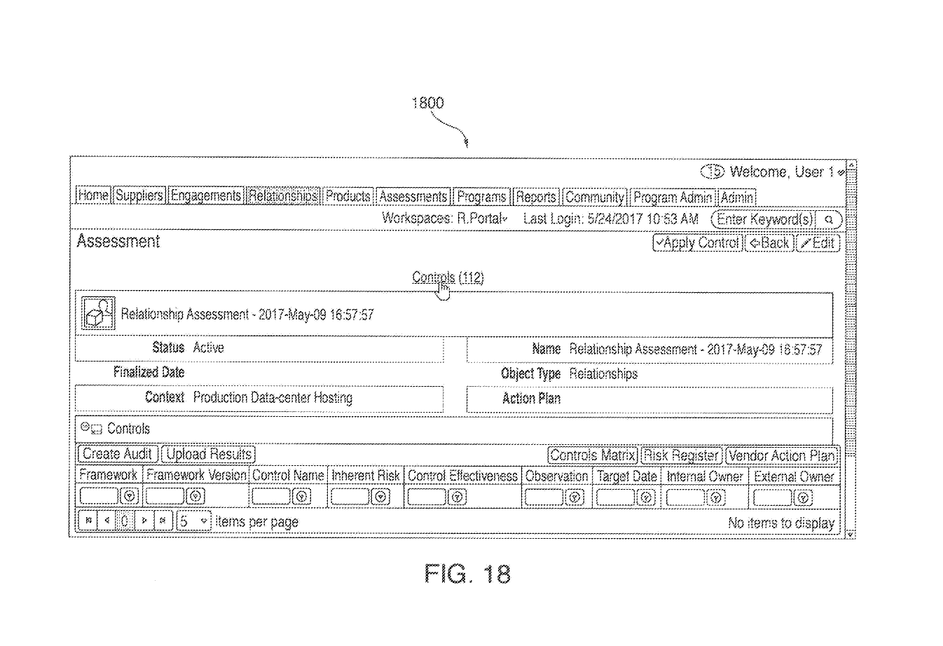

FIG. 18 shows GUI 1800. GUI 1800 may include a relationship assessment GUI. GUI 1800 may enable a user to assess a relationship, such as relationship R1000, shown in GUIs 1600 and 1700.

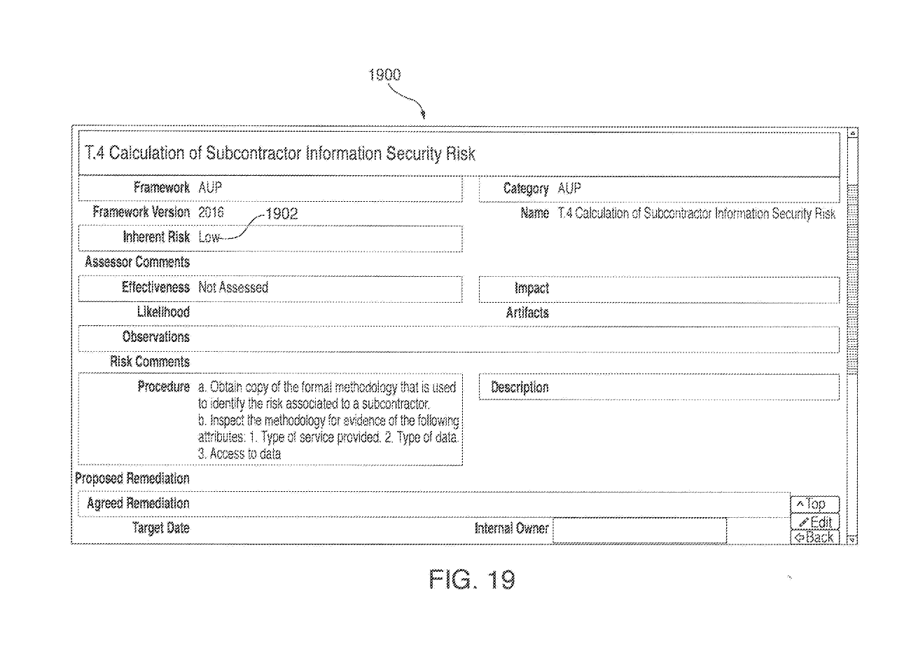

FIG. 19 shows GUI 1900. GUI 1900 may enable risk calculation of a control as evaluated compared to an entity-vendor relationship. The evaluated control, which may be specific to an entity-vendor relationship, may be determined to be of low risk to the entity, as shown at 1902.

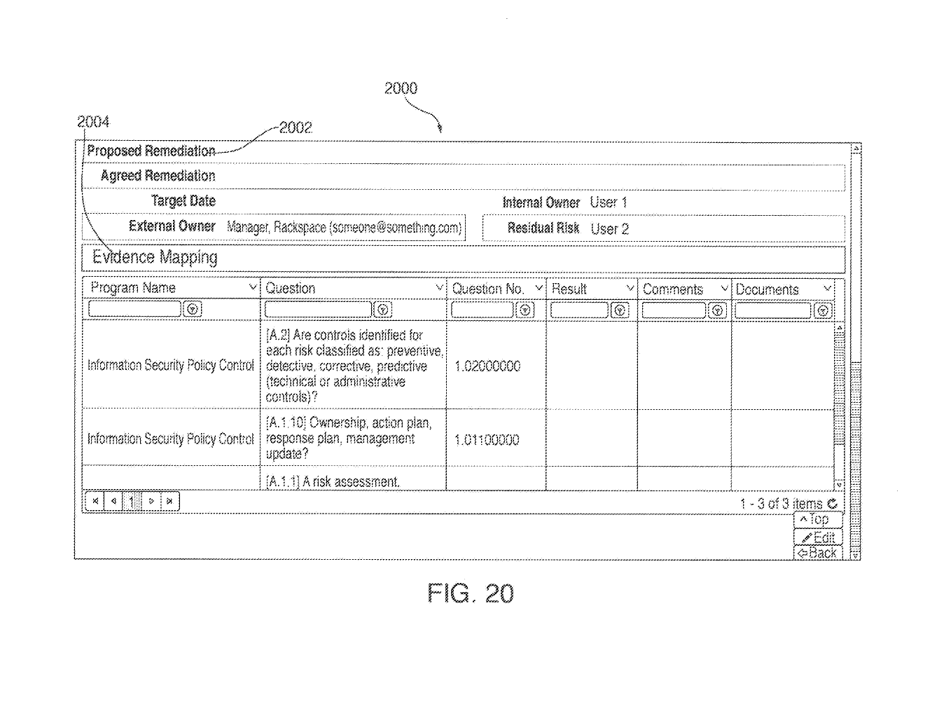

FIG. 20 shows GUI 2000. In the event that a control, compared to an entity-vendor relationship, is evaluated to be greater than a predetermined threshold, a remediation may be proposed, as shown at 2002. Evidence mapping, or queries associated with the control may be shown at 2004.

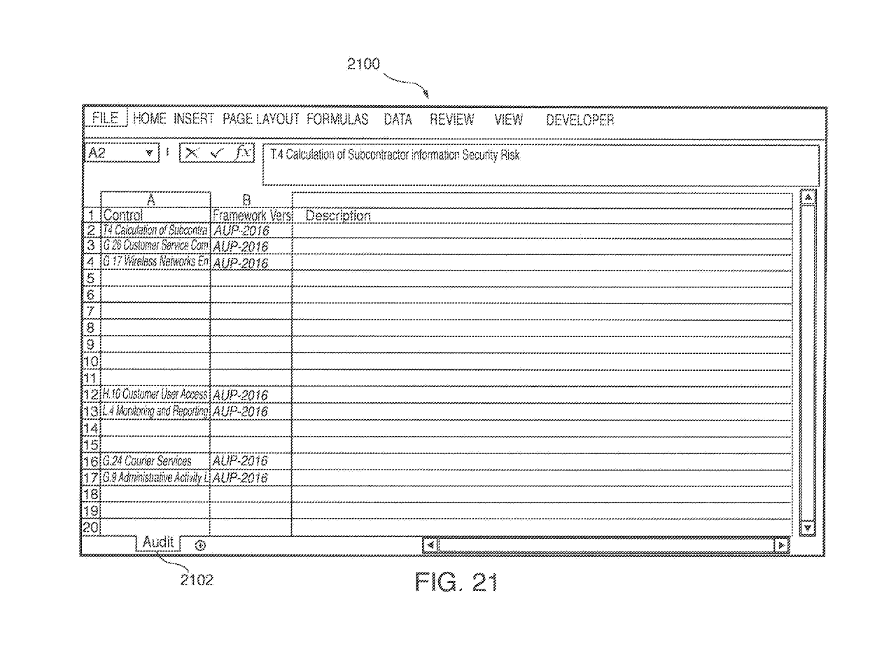

FIG. 21 shows GUI 2100. GUI 2100 shows evidence mapping displayed on a spreadsheet. The evidence mapping spreadsheet may include columns: control, framework version and description. The columns may be included in an audit tab, shown at 2102.

The control column may include exemplary controls: T.4 Calculation of subcontractor (which may relate to queries regarding subcontractor relationships for each third party vendor), G.26 Customer Service Communication (which may relate to queries regarding vendors involved in supporting customer service communications), G.17 Wireless Networks Enclosure (which may relate to queries regarding the wireless network enclosures of third party vendors), H.10 Customer User Access (which may relate to queries regarding customers of third party vendors and their access to the third party vendor networks), L.4 Monitoring and Reporting (which may relate to queries regarding monitoring and reporting of third party vendor activity), G.24 Courier Services (which may relate to queries regarding courier services used by third party vendors) and G.9 Administrative Activity Ledger (which may relate to third party vendor managing and recording of administration activities).

The listed controls may be included in a framework named AUP-2016. The controls may be included in other frameworks such as NIST CSF (National Institute of Standards and Technology Cybersecurity framework), NIST SP800-53 Rev 4 (National Institute of Standards and Technology Special Publication Security Controls and Assessment Procedures for Federal Information Systems and Organizations), ISO 27001/27002 (International Organization for Standardization Information security management systems), PCI (a standard for connecting computers and their peripherals), HIPAA compliance (Health Insurance Portability and Accountability Act of 1996 is United States legislation that provides data privacy and security provisions for safeguarding medical information), COSO compliance (The Committee of Sponsoring Organizations of the Treadway Commission), COBIT compliance (Control Objectives for Information and Related Technologies), etc.

The control system may save time and effort by determining a list of controls, relevant information and assessment data that is needed to satisfy the controls information requirements. Documents may be required for specific controls.

An example of a control may be password management. A test on the control may be named “testing control-effective password management policies.” Questions regarding password management policies may include “is password complexity required?” and “how often are employees required to change their passwords?”

Documentary evidence associated with password management may be password policies and procedures documents. These documents may be placed in a platform. The documentary evidence may enhance the effectiveness of the system.

Another facet of the invention relates to storage and viewability of retrieved information. Because all of the data is stored in a database, as opposed to disparate spreadsheets, an entity executive can easily view which third party vendors failed a specific control. The entity executive can also generate reports based on the relationships defined within the database. This saves many hours of retrieving information from different sources and reduces human error associated with retrieving the information.

The system also enforces an internal entity regulation standard. The system also enforces consistency of the process within an entity. For example, every time the entity assesses a third party vendor for a specific kind of service, documents A and B may be required because the specific kind of service has a predetermined control mapped to it.

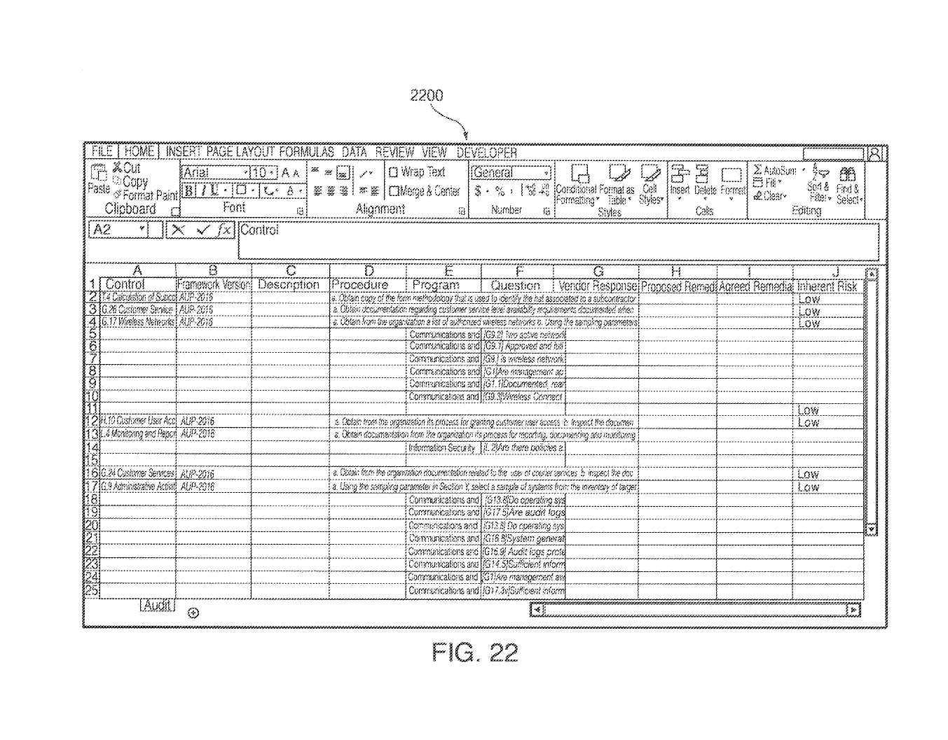

FIG. 22 shows GUI 2200. GUI 2200 may include audit information associated with control displayed on spreadsheet. The audit information may include control names, as shown in GUI 2100, framework version names, as shown in GUI 2100, description, procedure (obtain copy of the form methodology that is used to identify the risk associated to a subcontractor, obtain documentation regarding customer service level availability requirements documented within, obtain from the organization a list of authorized wireless networks, using the sampling parameters, obtain from the organization its process for granting customer user access, inspect the documents, obtain documentation from the organization of its process for reporting, documenting and monitoring, obtain from the organization documentation related to the use of courier services, using the sampling parameters in section Y, select a sample of system from the inventory of target), program (communications and networks and information security), question, vendor response, proposed remediation, agreed remediation, inherent risk (high, low, medium) and residual risk.

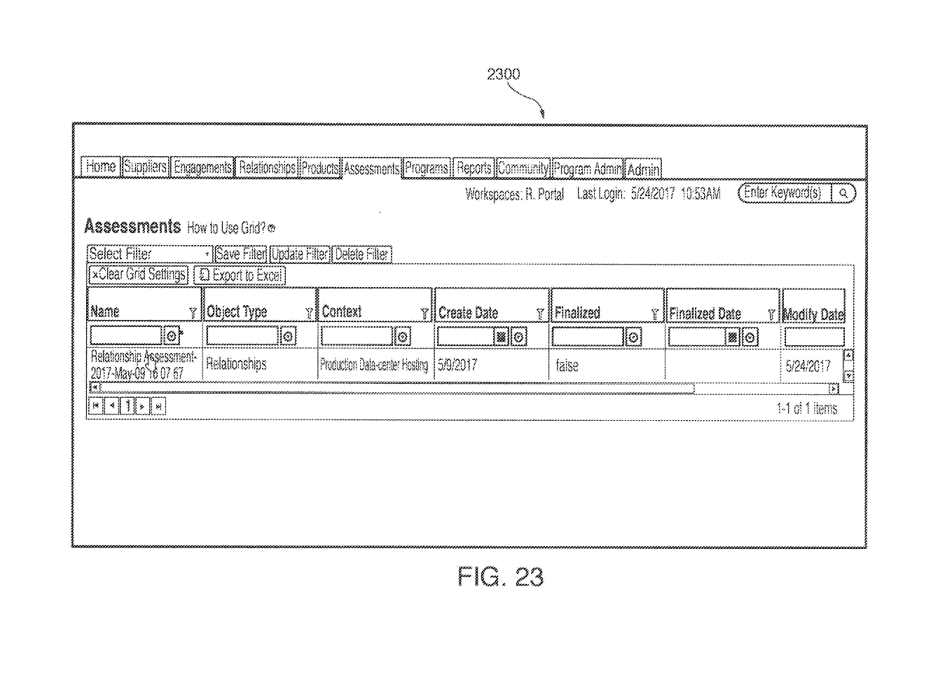

FIG. 23 shows GUI 2300. GUI 2300 may also show an audit associated with a control displayed on a spreadsheet.

One exemplary procedure shown may be:
a. obtain copy of the format methodology that is used to identify the risk associated with a subcontractor;
b. inspect the methodology for evidence of the following attributes:
   1. type of service provided;
   2. type of data; and
   3. access to data.

Another exemplary procedure shown may be:
a. obtain documentation regarding customer service level availability requirements documented within their service level agreements
b. inspect the documentation for the following attributes:
   1. process for client

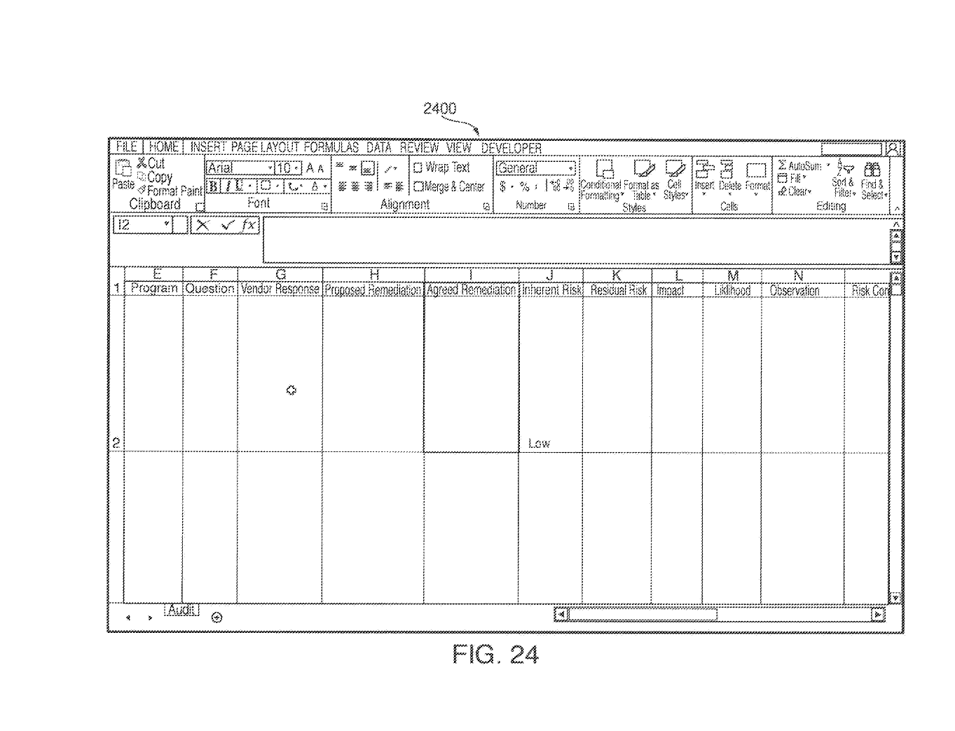

FIG. 24 shows GUI 2400. GUI 2400 may include a continuation of GUI 2300.

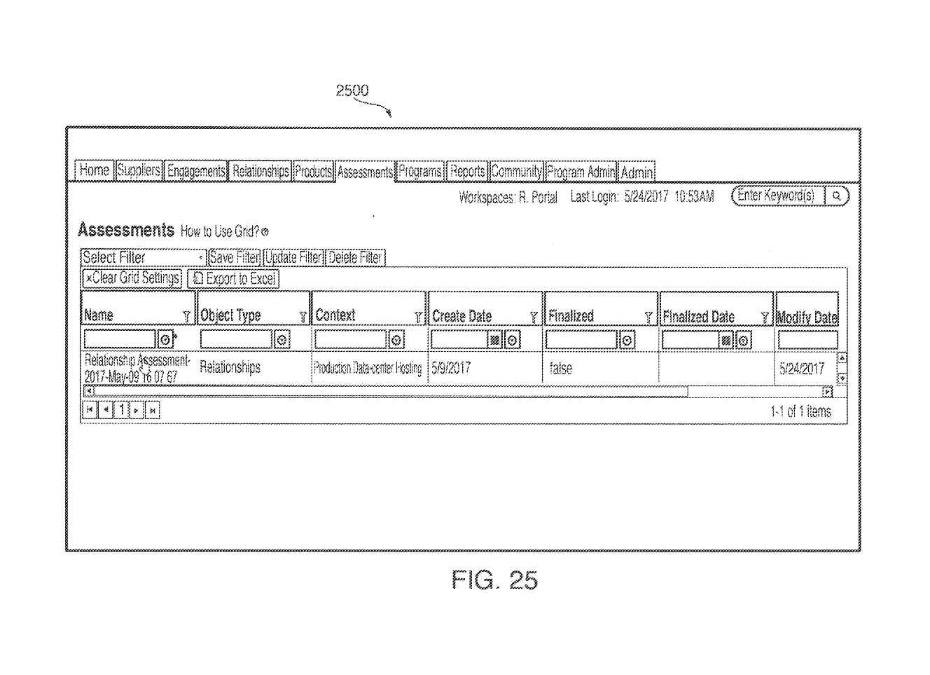

FIG. 25 shows GUI 2500. GUI 2500 may include a relationship assessment performed on a specific date. A user may create changes in the spreadsheets shown in GUIs 2200-2400. The spreadsheets may then be uploaded to assessments GUI 2500. The information in the spreadsheets may be entered into the system without requiring a user to enter each entry. The changes inputted by the spreadsheet may be presented to the user for verification purposes.

Thus, methods, apparatus and architecture for implementing a controls module have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for control-questionnaire relationship mapping comprising:
receiving entity information from an entity;
transmitting a standard information gathering (“SIG”) questionnaire to either one of the entity, a vendor or a third party, said SIG questionnaire relating to the vendor, the entity and a relationship between the vendor and the entity, said SIG questionnaire being based in part on the entity information;
receiving, from the entity, the vendor or the third party, the SIG questionnaire populated with a SIG response result set;
processing the SIG questionnaire populated with the SIG response result set, said processing comprising using a control-questionnaire relationship map to determine a set of controls applicable to both the entity and the vendor, wherein:
each control, included in the determined set of controls, is associated with a plurality of evidence questions;
a subset of the plurality of evidence questions associated with a first control, included in the determined set of controls, is identical to a subset of the plurality of evidence questions associated with a second control, included in the determined set of controls;
creating an evidence questionnaire for the vendor, said evidence questionnaire comprising the evidence questions associated with each of the determined set of controls, said creating the evidence questionnaire comprising discarding duplicate evidence questions while maintaining a relationship between each evidence question remaining following the discarding, included in the evidence questionnaire, and each control associated with each evidence question;
transmitting the evidence questionnaire to the vendor;
receiving, from the vendor, the evidence questionnaire populated with an evidence response set, said evidence response set comprising:
one or more data elements;
one or more pieces of evidence; and/or
one or more documents; and
storing the received evidence response set.

2. The method of claim 1, wherein the evidence questionnaire is agnostic to which questions, included in the evidence questionnaire, is associated with which controls.

3. The method of claim 1, wherein a data element, a piece of evidence or a document is mapped to a plurality of controls.

4. The method of claim 1, wherein the receiving entity information is static over a predetermined time for a predetermined entity.

5. The method of claim 4, further comprising:
transmitting a plurality of SIG questionnaires, each of the SIG questionnaires being associated with one of a plurality of vendors, to either one of the entity, the one of the plurality of vendors with which the SIG questionnaire is associated or one of a plurality of third parties;
receiving the SIG questionnaires, each of the SIG questionnaires being populated with a SIG response result set;
processing each of the SIG questionnaires;
for each SIG questionnaire, determining a set of controls applicable to both the entity and the vendor;
in response to determining a set of controls, creating an entity-specific and vendor-specific evidence questionnaire for each of the plurality of vendors;
for each of the plurality of vendors, transmitting the entity-specific and vendor-specific questionnaire that specifies the vendor to which the entity-specific and vendor-specific questionnaire is being transmitted;
receiving at least one of the vendor-specific evidence questionnaires populated with an evidence response set, said evidence response set comprising:
one or more data elements;
one or more pieces of evidence; and/or
one or more documents;
storing the at least one received evidence response set; and
mapping each data element, each piece of evidence and/or each document in the at least one evidence response set to the set of controls applicable to both the entity and the vendor.

6. The method of claim 1, wherein the determined set of controls comprises an acceptable use policy information security and infrastructure risk governance control.

7. The method of claim 6, wherein the evidence questions associated with the acceptable use policy information security and infrastructure risk governance control requests documents associated with a risk assessment program.

8. The method of claim 6, wherein the evidence questions associated with the acceptable use policy information security and infrastructure risk governance control requests:
services organization controls 2 (SOC2);
risk governance plan;
acceptable use policy;
business continuity policy/disaster recovery policy;
risk policy and procedures;
range of business assets to be evaluated;
risk training plan;
risk scenarios;
risk evaluation criteria; and/or
periodic review of program documentation.

9. A system for control-questionnaire relationship mapping comprising:
an entity information receiving module for receiving entity information from an entity;
a standard information gathering (“SIG”) module for:
transmitting a SIG questionnaire to either one of an entity, a vendor or a third party, said SIG questionnaire relating to the vendor, the entity and a relationship between the vendor and the entity;
receiving, from the entity, vendor or the third party, the SIG questionnaire populated with a SIG response result set;
using a control-questionnaire relationship map to process the SIG questionnaire populated with the SIG response result set to determine a set of controls applicable to both the entity and the vendor, wherein:
each control, included in the determined set of controls, is associated with a plurality of evidence questions; and
a subset of the plurality of evidence questions associated with a first control, included in the determined set of controls, is identical to a subset of the plurality of evidence questions associated with a second control, included in the determined set of controls;
an evidence questionnaire module for:
generating an evidence questionnaire specific to the vendor, said evidence questionnaire comprising a unique set of evidence questions, said unique set of evidence questions comprising the evidence questions associated with each of the determined set of controls for the specific vendor;
maintaining an evidence questionnaire relationship map, said evidence questionnaire relationship map associating each evidence question, included in the unique set of evidence questions, to the one or more controls to which the evidence question is associated;
transmitting the evidence questionnaire to the vendor; and
receiving, from the vendor, the evidence questionnaire populated with an evidence response set, said evidence response set comprising:
one or more data elements;
one or more pieces of evidence; and/or
one or more documents;
an updater module for updating the evidence questionnaire relationship map to include the received evidence response set; and
a database for storing:
the received evidence questionnaire; and
the updated evidence questionnaire relationship map.

10. The system of claim 9, wherein a subset of the determined set of controls is one or more entity-defined controls.

11. The system of claim 9, wherein the updater module:
deletes the evidence questions from the evidence questionnaire relationship map; and
maintains the relationship between each response included in the evidence response set and the set of controls.

12. The system of claim 9, wherein the evidence questionnaire is agnostic to which questions, included in the evidence questionnaire, are associated with which controls.

13. The system of claim 9, wherein a data element, piece of evidence or document is mapped to a plurality of controls.

14. The system of claim 9, wherein the entity information is static for a predetermined entity.

15. The system of claim 9, wherein:
the SIG module is further configured to:
transmit a plurality of SIG questionnaires, each of the SIG questionnaires being associated with one of a plurality of vendors, to either one of the entity, one of the plurality of vendors with which the SIG questionnaire is associated or one of a plurality of third parties;
receive the SIG questionnaires, each of the plurality of SIG questionnaires being populated with a SIG response result set;
process, using the control-questionnaire relationship map, the SIG questionnaire populated with the SIG response result set to determine, for each vendor included in the plurality of vendors, a set of controls applicable to the vendor, included in the plurality of vendors, and the entity;
the evidence questionnaire module is further configured to:
generate an entity-specific and vendor-specific evidence questionnaire for each of the plurality of vendors, said entity-specific and vendor-specific evidence questionnaire that specifies the vendor to which the entity-specific and vendor-specific evidence questionnaire is being transmitted;
maintain an evidence questionnaire relationship map for each entity-specific and vendor-specific evidence questionnaire;
transmit each entity-specific and vendor-specific evidence questionnaire to the vendor specified in the entity-specific and vendor-specific evidence questionnaire;
receive, from at least one vendor included in the plurality of vendors, the entity-specific and vendor-specific evidence questionnaire populated with an evidence response set, said evidence response set comprising:
one or more data elements;
one or more pieces of evidence; and/or
one or more documents;
the updater module further configured to update the evidence questionnaire relationship map to include the received evidence response set; and
the database further configured to store the updated evidence questionnaire relationship map.

16. The system of claim 9, wherein the determined set of controls comprises an acceptable use policy information security and infrastructure risk governance control.

17. The system of claim 16, wherein the evidence questions associated with the acceptable use policy information security and infrastructure risk governance control comprise requesting documents associated with a risk assessment program.

18. The system of claim 16, wherein the evidence questions associated with the acceptable use policy information security and infrastructure risk governance control requests:
services organization controls 2 (SOC2);
risk governance plan;
acceptable use policy;
business continuity policy/disaster recovery policy;
risk policy and procedures;
range of business assets to be evaluated;
risk training plan;
risk scenarios;
risk evaluation criteria; and/or
periodic review of program documentation.

19. A controls module comprising:
a transmitter configured to transmit a first set of queries to an entity;
a receiver configured to receive, from the entity, a result set corresponding to the first set of queries;
a processor configured to process the result set, said processing of the result set comprising using a query/control relationship map to determine a second set of queries, from a plurality of queries, said second set of queries being applicable to the entity, said query/control relationship map mapping the first set of queries to the second set of queries via a plurality of controls, each of the plurality of controls being associated with at least one query included in the second set of queries;
the transmitter further configured to transmit the second set of queries to a plurality of vendor entities;
the receiver further configured to receive, from one or more of the plurality of vendor entities, one or more result sets corresponding to the second set of queries; and
the processor further configured to map each result, included in each result set, corresponding to the second set of queries, to the control with which the result is associated.

20. The system of claim 9, wherein the process is further configured to:
delete the second set of queries from the query/control relationship map; and
maintain the relationship between each result included in each result set and the set of controls.
